(19) United States
(12) Patent Application Publication
(10) Pub. No.: US 2018/0022310 A1
(43) Pub. Date: Jan. 25, 2018

(54) AIRBAG SYSTEM FOR USE WITH UNMANNED AERIAL VEHICLES

(71) Applicant: Rhombus Systems Group, Inc., Philadelphia, PA (US)

(72) Inventor: Erlend Olson, Newport Beach, CA (US)

(73) Assignee: Rhombus Systems Group, Inc., Philadelphia, PA (US)

(21) Appl. No.: 15/469,128

(22) Filed: Mar. 24, 2017

Related U.S. Application Data
(60) Provisional application No. 62/312,635, filed on Mar. 24, 2016.

(51) Int. Cl. B60R 21/36; B64C 25/56; B64C 39/02; B60R 21/0132

(52) U.S. Cl. CPC B60R 21/36; B60R 21/0132; B64C 25/56; B64C 39/024; B64C 2201/18; B60R 2021/0093

(57) ABSTRACT

A system for deploying an airbag when an unmanned aerial vehicle (UAV) has failed or is no longer able to sustain flight, comprising a triggering means which releases compressed air into a bag or bags which are configured to expand around the UAV for the purpose of reducing the deceleration forces of the UAV on impact. UAV's are provided that are configured with a system that includes a triggering mechanism that deploys one or more bags when there is a failure or when flight is no longer sustainable.

### CROSS-REFERENCE TO RELATED APPLICATIONS

This patent application claims the benefit under 35 U.S.C. 119 and 35 U.S.C. 120 of U.S. provisional application Ser. No. 62/312,635 entitled “Airbag System for use with Unmanned Aerial Vehicles”, filed Mar. 24, 2016, the complete contents of which is herein incorporated by reference.

### BACKGROUND OF THE INVENTION

### 1. Field of the Invention

The present invention relates to safety apparatus for airborne crafts, and, in particular, for unmanned aerial vehicles, and more particularly, a system to safeguard objects and individuals from potential encounters with unmanned aerial vehicles that unexpectedly descend due to a failure or have lost control.

### 2. Brief Description of the Related Art

Unmanned aerial vehicles may be employed for carrying out surveillance, police and investigative activity, architectural and land planning, inspections, sporting events, as well as other uses where a view from an elevated position is desirable and/or where a subject of interest may be in motion. As the popularity of the unmanned aerial vehicles increases, the vehicles may be used where there are people or objects below. While vehicles remaining airborne typically are out of the way of objects below them, there are instances where a vehicle may lose control or cease operating. In these instances, the unmanned aerial vehicle may pose a safety concern, particularly where a user or organization no longer has control of the vehicle. The natural tendency for a vehicle, say, for example, one that has lost power, is to descend. The descent may be a number of trajectories. In some instances, the unmanned aerial vehicle may drop in a substantially straight path to the ground, subject to the effects of air resistance, wind and air currents. In other instances, the unmanned aerial vehicle may continue along a path of travel, with significant speed, but on a declining altitude. In yet other circumstances, the failure may be control or steering, where the aerial vehicle still travels, but in a manner not intended or controlled, and instead of (or prior to) dropping to the ground, may collide with an elevated structure, such as, a building. These situations pose risks to those in the path of the vehicle, which may include individuals, animals and objects on the ground, as well as buildings or other vertically raised structures in the path of the vehicle.

Problems therefore exist today with unmanned aerial vehicles (UAVs), in that they can fail unexpectedly. Especially the so-called quad-copter and octo-copter hovering type UAVs have failure modes where the aerial vehicle can literally fall from the sky. Some of the failures associated with these UAV's, for example, may include, battery back-up failure, motor failure, and structural failures. Although there is the potential damage to the UAV, the potential harm to individuals and other objects may be much more severe. By way of example, a 25 lb object dropped with minimal air resistance from 150 ft lands at V=SQRT(2×A×D) equals approximately 70 mph, in less than 3 seconds. The kinetic energy of the 25 lb object from 150 ft on impact is ½ m v2=9000 joules. This is comparable to the energy released by a 50-cal combat heavy machine gun bullet on impact. So even a small 25 lb UAV falling from an altitude of only 150 feet out of the sky is potentially lethal if it strikes a person or animal on impact. A UAV falling from higher altitude has even more energy on impact, especially if it has minimal air resistance in an uncontrolled decent.

One solution that has been offered is a parachute that deploys rapidly. However, a parachute is problematic for two reasons. First, if the aerial vehicle is tumbling as it descends, then the parachute may not deploy properly, even if it is ejected from a container with force. Secondly, if the aerial vehicle is close to the ground, there may be insufficient time for even a properly deployed parachute to slow an aerial vehicle's decent sufficiently to prevent injury or even death to people or animals, or to prevent damage to property, on impact.

### SUMMARY OF THE INVENTION

A safety system for safeguarding the operation of unmanned aerial vehicles (UAVs), and unmanned aerial vehicles configured with a safety deployment system are provided. According to preferred embodiments, the system and vehicle are configured to deploy one or more safety components upon a condition of a failure. The system and vehicle preferably are configured to recognize one or more conditions designated as a failure condition, and deploy protection upon detection of a condition. Preferred embodiments provide deployable safety components comprising one or more inflatable bags (which may be referred to herein as airbags, though they may be inflated with gasses other than air). The deployment of inflatable airbags not only increases air resistance and thereby slows the decent and ultimate terminal velocity of the UAV, but also provides a cushion on impact. The airbags, when deployed preferably minimize or prevent the major mass of the UAV from releasing its kinetic energy as rapidly as it would otherwise into a person, animal or property on which it impacts.

According to preferred embodiments, the system is configured to deploy an airbag when a UAV has failed or is no longer able to sustain flight, and preferably includes a triggering means which releases compressed air into a bag or bags which are configured to expand around the UAV for the purpose of reducing the deceleration forces of the UAV on impact.

According to some preferred embodiments, the UAV preferably includes a power supply, such as, for example, a battery (and may include solar cell power), and one or more rotors or propellers. The vehicle preferably has an operating mechanism which includes a steering configuration, and is operable to control the speed and/or positioning of the rotors to regulate the altitude, speed and direction of the vehicle. The pitch of the rotors may be controlled. The vehicle preferably also includes communications hardware for receiving and transmitting signals. Some embodiments of the system and device may configure the communications hardware to exchange communications between the vehicle and a remote component, such as, for example, an operating control, transmitter, monitoring station, command control, or screen. Embodiments of the system and vehicle also may include one or more cameras.

Preferred embodiments of a vehicle implementing the system preferably include a computer, which includes a processing component, such as a processor, and, according to some embodiments, may be configured as a microcircuit, microcontroller or microprocessor. The computer may include a storage component (which may be part of the circuitry or separately provided), that includes software with instructions for monitoring the inputs, such as control signals, as well as flight properties (acceleration, direction, pitch, yaw) and controlling the rotor operation to produce stabilization for the intended flight. According to preferred embodiments, the vehicle circuitry also is configured with software for monitoring operations or one or more conditions of operation, and providing a response when an operating condition is detected or when it reaches or exceeds a threshold.

Aerial vehicles also may be configured with components for navigation, such as, for example, a GPS and compass, which may be provided on a chip or circuitry. The vehicle preferably may be configured with an electronic speed control that may be embodied to comprise software, hardware, circuitry, or combinations thereof, to manage the operation of the motors that drive the rotors as well as changes to the rotor orientation (e.g., by changing the motor shaft direction).

Embodiments of the vehicle may include software provided with one or more stabilization algorithms for smoothing the operation control and flight properties of the vehicle, as instructions are carried out and the vehicle implements instructions from a controller controlling its flight, or autonomously from a predetermined set of controls.

According to some embodiments, a vehicle may be configured to detect a condition signifying an undesired condition. For example, a structural defect, or failure of one or more components, such as, motor failure, may be detected. Upon detection of the condition, the vehicle deploys the safety component, which comprises one or more airbags. The airbags preferably are coupled to the circuitry of the vehicle, and the airbags are configured with an actuator for actuating an inflation mechanism (such as, for example, a release of compressed gas (e.g., air), or a gas producing charge or emission). The software preferably includes instructions for monitoring the vehicle operation, and, for example, where a condition is detected that places the vehicle (or others) in potential peril (e.g., for descending, or being unable to effectively be controlled), a triggering response is initiated, triggering the deployment of the safety mechanism, such as the airbags.

The deployment of the safety mechanism may include inflation of the airbags, as well as one or more additional functions, such as, transmitting an alert, or disabling a function of the vehicle (e.g., cutting power to the rotors).

According to some embodiments, vehicles may be configured to operate autonomously, in accordance with a flight plan or other predetermined instruction, or pursuant to a set of rules or conditions. For example, where a vehicle is engaged in surveillance activity, the vehicle may operate in an autonomous mode, to cover a particular geographic area or boundary.

According to some embodiments, the system may be configured so that upon detection of a failure condition, deployment may be immediate. According to some other embodiments, the deployment may be set to delay, which may be a very brief delay (for example, where the altitude is significantly high, and there is a chance the condition may be remedied, e.g., by manual override, or a second or resumption of a transmission). According to some embodiments, the triggering condition may be set to measure a condition, and some embodiments may measure a rate at which a condition is occurring, such as, for example, the rate of decline of altitude (Δaltitude/Δtime), or other parameter. According to yet other embodiments, the deployment may be remotely triggered (such as, from a transmission received, e.g., from a communicating controller), which may be alternative to or in addition to a detection triggered deployment.

According to some preferred embodiments, one or more functions and operation of the UAV may be shut down. The shutdown of functions preferably may be coordinated to coincide with the deployment of a safety component, such as the airbag deployment.

According to some preferred embodiments, the safety component may comprise an airbag (or airbags) carried on the UAV. In some preferred embodiments, an arrangement of one or more airbags is provided to cover or envelop the UAV.

According to some preferred embodiments, the airbags are provided within the structural framework of the UAV. According to some other embodiments, the airbags may be mounted at locations on the UAV structure.

According to some embodiments, the system may be utilized in conjunction with unmanned aerial vehicles, including fixed wing unmanned aerial vehicles, and other vehicles, such as, octocopters and quadcopters.

### BRIEF DESCRIPTION OF THE DRAWING FIGURES

FIG. 1A is a front elevation view depicting an exemplary embodiment of an unmanned aerial vehicle illustrated with the safety component in an undeployed condition.

FIG. 1B is a front elevation view of the unmanned aerial vehicle of FIG. 1A shown with the safety component deployed.

FIG. 2 is a flow diagram of a depiction of an exemplary embodiment of the system operation.

### DETAILED DESCRIPTION OF THE INVENTION

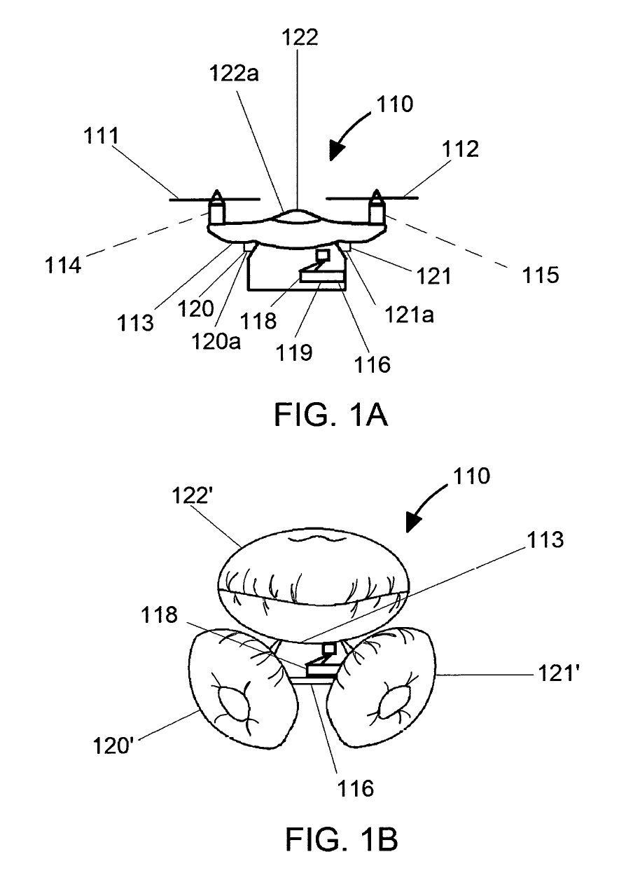

A safety system and unmanned aerial vehicles configured with a safety system are provided. Embodiments of the system and an unmanned aerial vehicle (UAV) implementing the system are illustrated in reference to FIGS. 1A and 1B, where the UAV 110 is shown. The UAV 110 illustrates an exemplary embodiment of an unmanned aerial vehicle implementing a safety system. The UAV 110 is depicted in an elevation view, configured as a quadcopter having four rotors 111,112 (the other two rotors being behind the rotors 111,112, and not shown). The vehicle 110 is shown having a housing 113 for housing the components therein. The rotors 111,112 are operably connected to motors 114,115, respectively, which regulate the speed of the rotors 111,112. Motors not shown also are provided to operate the rotors (not shown) which are situated immediately behind the rotors 111,112. The rotors, including those rotors 111,112 shown in FIGS. 1A and 1B, preferably are movably mounted, and are controllable to regulate the operations of the vehicle 110, such as, to control its altitude, speed and direction. The quadcopter 110 includes landing gear for protecting and stabilizing the vehicle 110 upon landing on a surface. The landing gear, according to an exemplary embodiment, is shown comprising a flange 116 (and there may be a second flange, not shown, behind the flange 116). According to preferred embodiments, the vehicle 110 preferably is constructed with a frame (not shown) on which the components of the vehicle are supported. The flange 116 preferably is connected to the frame. A camera mounting structure 118 is shown supporting a camera 119 thereon. The camera mounting structure 118 may be configured with one or more motors or controllable components that may be operated to position the camera 119 relative to the vehicle 110. According to preferred embodiments, a gimbal may be disposed as part of or in conjunction with the camera mounting structure 118 to facilitate stabilization of the camera 119.

The exemplary embodiment of the vehicle 110 depicted in FIGS. 1A and 1B, is shown having a safety component. The safety component is illustrated comprising a plurality of airbags, which according to one preferred arrangement, includes airbags 120,121,122, with additional airbags (on the opposite side of the vehicle, situated behind the airbags 120,121. An upper airbag 122 is illustrated, and is preferably centrally located on the vehicle 110. Lower airbags 120,121 are located at opposite sides of the vehicle 110. The airbags 120,121,122 (and those not shown), preferably are configured in a respective housing 120a,121a,122a, and are associated with an actuating mechanism. According to one embodiment, the actuating mechanism is a gas mechanism that provides or generates gas to inflate the airbags 120,121,122. According to some embodiments, the gas is a compresses gas, provided from a compressed gas source. For example, the gas may comprise compressed air, which is held in a suitable container or reservoir on board the vehicle, in compressed form, and which is admitted to the airbags 120,121,122, upon actuation. An actuating mechanism preferably is provided to actuate the release of the compressed gas from the container or reservoir into the airbags 120,121,122. An electronically actuated signal generator may be coupled with a valve that opens to permit contents from the container (gas under compression) to exit the container and fill the airbags 120,121,122. A regulatable valve that may be controlled to release contents of a compressed gas (e.g., compressed air) from a reservoir, may be triggered upon an event requiring the airbags to deploy. The valve may be triggered from an electronic signal, or alternatively, may be mechanically triggered by another actuating component. The valve preferably provides the release of the pressurized gas to rapidly inflate one or more airbags. Preferably, the amount of gas is controlled, and each airbag 120,121,122 may receive its own supply, from a respectively associated container, or, alternatively, may be connected so that it is in communication with a single reservoir or container that supplies the compressed gas to one or more (or all) of the airbags 120,121,122 (and others). According to some embodiments, the airbags are configured so that each airbag requires the same amount of gas to inflate it. According to some embodiments, airbags may be configured so that they have the same internal volume. The gas supply to each airbag 120,121,122 (and any others) may be regulated so that the gas may be supplied from a single reservoir and the airbags receive the same pressure of gas, or alternatively, so that a restriction or valve is provided to supply an appropriate amount of gas to inflate each respective airbag (e.g., more to a larger volume bag, and less to a an airbag of smaller volume).

According to some other embodiments, a gas producing mechanism may generate gas to inflate the airbag 120,121,122. The gas may be generated by a chemical reaction, release of a pressurized component or other suitable inflation technique. An example of an actuating mechanism is an electronically actuated signal generator, which may be coupled with an ignitor, which ignites one or more chemicals (e.g., by heating or electric impulse) to produce gas. Preferably, the gas is generated or released in a rapid manner so as to immediately inflate the associated airbag. According to one exemplary embodiment, a nitrogen producing chemical compound is housed with the airbag. The chemical compound is configured with an actuator, such as, an ignitor, which receives an electronic signal, and heats a nitrogen producing compound, such as, for example, sodium azide (NaN₃), producing nitrogen gas which inflates the airbag. The sodium azide when actuated (e.g., ignited or heated), decomposes to sodium and nitrogen gas. According to alternate embodiments, other chemicals may be utilized (e.g., potassium nitrate).

According to some embodiments, one or more lubricating chemicals, (e.g., talc, cornstarch), also may be provided to facilitate the opening of the airbag and to reduce potential friction upon deployment when contacting the housing or other vehicle structures.

The vehicle 110 is shown with the airbags 120,121 and 122 arranged on the vehicle 110 and disposed away from a from conflict with the vehicle structures, such as, for example, the landing gear 116, housing 113, rotors 111,112, and camera support 118, affording a clear path for inflation of the airbags 120,121,122 upon their deployment.

Referring to FIG. 1B, the airbags 120′,121′,122′, are illustrated in a deployed condition where they are inflated, and emergent from their respective housings 120a,121a,122a (FIG. 1A). The housings 120a,121a,122a, may be configured as breakaway housings (where the air bag inflation pressure forces the airbag through the housing, and the housing separates or opens), or may have one or more doors that the airbag 120,121,122 when being inflated may force open. According to some embodiments, the containment for the airbag, such as, for example, the airbag housing, may be provided with doors, or other elements that serve to guide the path of the airbag when it is being inflated, so that interference with any vehicle structures is minimized or eliminated. As illustrated in FIG. 1B, the vehicle 110 is shown enveloped by the deployed airbags 120′,121′,122′ (and two additional air bags, not shown, which preferably are situated behind the airbags 120′,121′), which are inflated around the vehicle 110 and its components. The housings 120a,121a,122a (FIG. 1A), may be mounted to a frame or housing 113 of the vehicle 110. According to some preferred embodiments, one or more airbags may be arranged to envelope the UAV 110 completely on deployment.

Airbags 120,121,122 (and other airbags) may be configured to comprise airbag modules, where each airbag module, for example, may include a housing or casing, an inflatable bag or bladder, a gas supply and actuator (such as a valve or ignitor), and circuitry or leads for tripping the actuator.

According to preferred embodiments, the system is configured to operate in conjunction with the components of the UAV, such as, for example, the vehicle 110. The UAV, such as, for example, the vehicle 110, preferably includes a power supply, such as, for example, a rechargeable battery, and may additionally include a solar cell (or other power providing or generating source). The vehicle 110 preferably has an operating mechanism that includes a steering configuration and one or more controls for controlling the speed and positioning of the rotors 111,112 (and other rotors) to regulate the altitude, speed and direction of the vehicle 110. The vehicle 110 includes communications hardware for receiving and transmitting signals, which provides capability for the reception and/or exchange of communications (including datagrams) between the vehicle 110 and a remote component. For example, the remote component may comprise an operating control for controlling the operation of the vehicle 110, including its flight path, direction, speed, altitude, and other maneuvering capabilities. The remote component may also comprise or be linked with a monitoring station, which may include controls (such as a keyboard, or other input or device, e.g., joystick, and may have a screen display for showing images (including video) from the vehicle 110, as well as to display controls or conditions of the vehicle 110. Preferred embodiments of the vehicle preferably include a computer. The computer includes a processor, which, according to some embodiments, may be configured as a microcircuit, microcontroller or microprocessor. The vehicle or its computer may include a storage component (which may be part of the circuitry or a processing component, or separately provided). Preferably, software is provided on the vehicle circuitry or computing components that contains instructions for monitoring the inputs, such as control signals, as well as flight properties (e.g., acceleration, direction, pitch, and yaw). The software also may include instructions for controlling the rotor operations, and may include a stabilization algorithm to produce stabilization for the intended flight (for smoothing the operation control and flight properties of the vehicle as instructions are carried out and the vehicle implements instructions from a control, program, or other source).

Embodiments of the vehicles may be configured with navigation components or circuitry, which, for example, may include a GPS and compass, which may be provided alone or together on a chip or circuitry, and in some instances with one or more other components (e.g., an IMU). The vehicle preferably may be configured with an electronic speed control that may be embodied in the software, hardware, vehicle circuitry, or combinations thereof. The speed control mechanism preferably may be provided to manage the operation of the motors that drive the rotors as well as changes to the rotor orientation (e.g., by changing the motor shaft direction), and may function by receiving remote signals, or operate in conjunction with programming directing flight path, direction and other vehicle operations.

According to some embodiments, the system preferably is installed on the vehicle with sensors and circuitry configured to monitor conditions of operation of the vehicle. The system may provide separate computing components that are designed to function in conjunction with the airbags to trigger a deployment of the airbags when a condition is detected. The system preferably includes one or more sensors for sensing a condition of operation, and when the condition is detected, the airbag deployment is triggered. The sensors may include accelerometers, gimbals, inertial measurement units, altimeters, GPS components, compasses and other position and orientation sensors. The sensors also may include detection components to measure whether a motor powering a rotor is operable, for example, by determining whether current is being supplied to a rotor motor, or one of the other motors that positions the rotor. The system preferably includes software that is stored on a storage component of the circuitry, which may be embedded therein, programmable or reprogrammable. In some embodiments, the software and circuitry may be provided as part of the vehicle circuitry, and may be powered and operated with the vehicle components, including the vehicle battery and computing components. According to some other embodiments, the system is configured to function separately (or independently) of the vehicle components (e.g., such as, for example, with an already existing vehicle), and may trigger the deployment of the airbags using the components of the system. In some embodiments, the system may include separate operating circuitry, but may share power with the vehicle power source. The system also is configured with software for monitoring operations or one or more conditions of operation, and providing a response when a designated condition is detected or reaches a threshold. The software monitors the designated conditions of operation, which may include vehicle functions, such as rotor movement, motor operation, battery power, as well as, vehicle velocity, altitude, acceleration, pitch, yaw, direction, location, and other conditions that may be sensed by a sensor. According to some embodiments, the system sensors and software are electronically coupled with the trigger to deploy the airbags to provide a safe way to safeguard and decelerate the vehicle, when the vehicle would otherwise present a danger as a result of its failure or inability to sustain flight (or a desired flight direction).

The system preferably includes software that is configured to control the operations of one or more vehicle components, upon the sensing of a condition. According to some embodiments, the system is electronically coupled with the vehicle operating controls or components, so that the software may instruct a processing component (microprocessor, or the like) to disable power to one or more vehicle components. For example, when a condition occurs that triggers the deployment of the airbags, the system may shut down the vehicle, e.g., by cutting power to the rotors.

According to preferred embodiments, an accelerometer is provided and is coupled with the circuitry of the device 110. The accelerometer provides an output, which is processed and compared with a designated value. When the accelerometer exceeds a certain acceleration limit, the signal it produces is detected, and the designated threshold limit is identified by the software that instructs the processor (or microprocessor) to compare the values to the threshold. Upon confirmation of the threshold being met or exceeded, the instruction triggers the actuation mechanism to deploy the airbags 120,121,122. According to an exemplary embodiment, this may involve opening the valve and releasing compressed gas (e.g., compressed air), into the airbags to inflate them. The accelerometer threshold value may correspond with an indicative reading of free fall or other lack of controlled operation. This may be due to a number of potential failures or conditions, such as, for example, a damaged rotor, motor failure, low or no power, or avian animal collision.

According to some embodiments, in addition to accelerometers that detect and measure acceleration of the vehicle, the airbag deployment may be triggered by a loss of power to the motors that power the vehicle 110. For example, the vehicle circuitry may include a detector that is configured to monitor the current of one or more motors of an unmanned aerial vehicle, such as, for example, a fixed wing unmanned aerial vehicle, octocopter, or quadcopter (such as the quadcopter 110 depicted in FIGS. 1A and 1B).

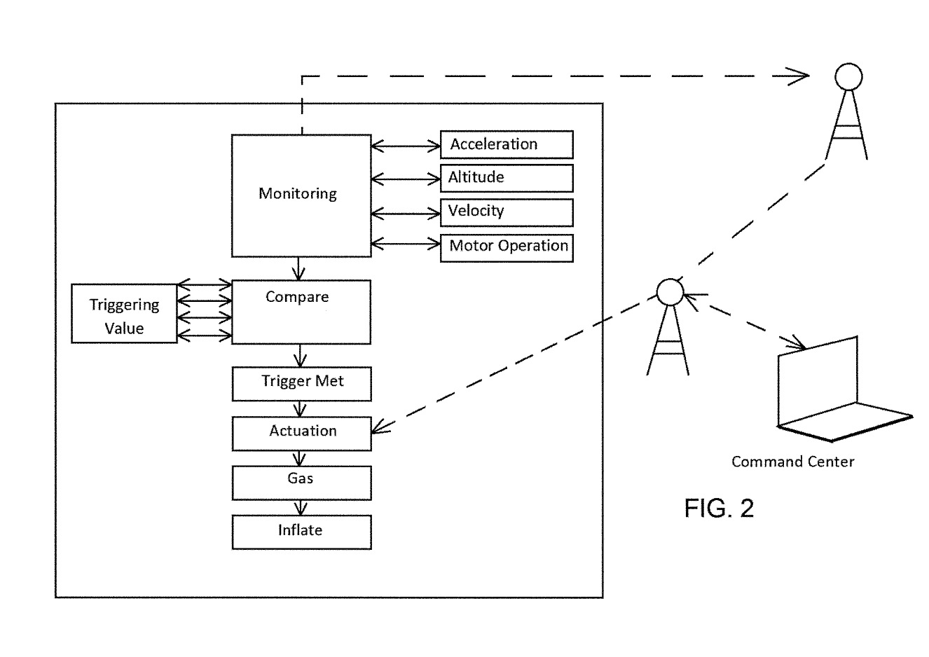

The system may be configured to receive a deployment command instructing or signaling the actuation of the protective system, and may inflate the airbags upon receiving the remote command. For example, a trigger of the airbag deployment may be caused by the issuance of a remote command which is issued via a datagram that is transmitted to the unmanned aerial vehicle over a wireless link, such as, for example, a communications network, cellular network, computer or other network. (See e.g., FIG. 2) The UAV preferably includes communication hardware and software to receive the intended communication. The UAV may be configured to receive communications over one or more, or a plurality of communication networks, and may receive a trigger over one or more network.

According to some embodiments, airbag deployment may be electronically coupled with one or more other functions of the UAV. For example, deployment of the airbags may include an electronic means for cutting power to all rotor motors. The circuitry may be configured with software which, upon triggering the actuation of the airbag deployment, also cuts the power to the rotor motors. According to some embodiments, deployment of the airbags may include a mechanical means for cutting power to all rotor motors.

According to preferred embodiments, the system, such as, for example, the implementation illustrated in conjunction with the vehicle 110 shown in FIGS. 1A and 1B, where an airbag system is provided on a UAV 110, preferably is configured so that when certain catastrophic failure conditions on the UAV are detected, the power to any rotors or propellers can be shut down and airbags 120,121,122 deployed. The airbags 120,121,122 will not only increase air resistance and thereby slow the decent and ultimate terminal velocity of the UAV 110, but will also provide a cushion on impact, preventing the major mass of the UAV from releasing its kinetic energy as rapidly as it would otherwise into a person, animal, property or other object on which it impacts. As is illustrated in FIGS. 1A and 1B, the vehicle 110 may travel and carry out functions unimpeded by the airbags 120,121,122 (see FIG. 1A), and upon the detection of a condition, may deploy the airbags by inflating them to the condition as represented by FIG. 1B, which safeguards the vehicle 110.

In the exemplary embodiment illustrated in FIGS. 1A and 1B, the vehicle 110 is configured with five airbags. According to some other embodiments, vehicles may be constructed with fewer or greater numbers of airbags. According to some preferred embodiments, the airbags are deployed in an arrangement whereupon one of the airbag's engagement with an object, such as, a person, vehicle, or other item, one or more of the other airbags also may provide support. The airbag system may provide airbags installed at locations on the vehicle, and having suitable sizes to cover the components of the vehicle which are arranged to provide suitable protection from the vehicle and its structures upon engagement with an individual, animal or other object.

The system and vehicle 110 preferably are configured to recognize one or more conditions designated as failure condition, and deploy upon detection of a condition. Suitable circuitry is provided to regulate the deployment operations and functions of the airbags 120,121,122. Referring to FIG. 2, an exemplary depiction of an implementation of the system is illustrated, showing an arrangement where the system is configured with communications capability to communicate and receive transmissions. The embodiment illustrates a computer, shown situated at a command center.

The unmanned aerial vehicle, such as, the exemplary embodiment depicted in FIGS. 1A and 1B, configured as a quadcopter 110, preferably includes components that are required for the vehicle operation and flight. For example, according to some preferred embodiments, the unmanned aerial vehicle preferably includes a power supply, such as, for example, a battery, which may be rechargeable, (and may include a solar cell, to provide power, auxiliary power, or for charging), and one or more rotors (preferably four in the quadcopter embodiment), and motors respectively associated with each of the rotors for positioning the rotors to maneuver the vehicle 110. The vehicle 110 preferably has an operating mechanism which includes a steering configuration, and is operable to control the speed and/or positioning of the rotors 111,112 (and those not shown) to regulate the altitude, speed and direction, pitch and yaw, of the vehicle 110. The vehicle 110 may include navigation components, such as, for example, accelerometers, gimbals, inertial measurement units, altimeters, and other position and orientation sensors. The pitch of the rotors may controlled by operating motors associated with the respective rotors, which may be operated in pairs, or individually, etc.

The vehicle 110 preferably also includes communications hardware for receiving and transmitting signals. Embodiments may configure the communications hardware for communications between the vehicle 110 and a remote component, such as, for example, an operating control, monitoring station, or screen. Embodiments of the vehicle also may include one or more cameras, such as the camera 119. The camera 119 may communicate real-time images (video or still frames), and may be manipulated with one or more motors (not shown) that position the camera 119 to a desired or designated point of interest. The communications hardware preferably is associated with the power supply and may be coupled together with the circuitry that is used to regulate the operation of the vehicle functions.

According to preferred embodiments, the vehicle circuitry also is configured with software for monitoring operations or one or more conditions of operation, and providing a response when a condition is detected or reaches a threshold. The vehicle preferably includes operating software with instructions to receive inputs from a remote communication component (e.g., from a direct source or over a network) and carry out instructions received. The vehicle 110 may be controlled and its travel directed, or according to some other embodiments, the vehicle 110 may be configured with instructions to autonomously travel is one or more designated zones or in accordance with conditions.

According to some embodiments, the vehicle may detect a condition signifying an undesired condition. For example, a structural defect, or failure of one or more components, such as, motor failure, may be detected. Upon detection of the condition, the vehicle deploys the safety component, which comprises one or more airbags. The airbags preferably are coupled to the circuitry of the vehicle (or other sensor configured circuit carried on the vehicle), and the airbags are configured with an actuator for actuating an inflation mechanism (such as, for example, a gas producing charge or release). The software preferably includes instructions for monitoring the vehicle operation, and, for example, where a condition is detected that places the vehicle (or others) in potential peril (e.g., for descending, or being unable to be effectively controlled), a triggering response is initiated, triggering the deployment of the safety mechanism, such as the airbags.

The deployment of the safety mechanism may include inflation of the airbags, as well as one or more additional functions, such as, transmitting an alert or overriding a control of one or more vehicle operations.

According to some preferred embodiments, the airbags are provided within the structural framework of the UAV. According to some other embodiments, the airbags may be mounted at locations on the UAV structure. The airbags may be mounted as modules comprising the airbag bag, and one or more components to actuate and/or inflate the bag. The modules, for example, may include one or more inflatable bags, as well as actuation circuitry and a trigger mechanism (e.g., actuator), and may be configured to sense one or more conditions (e.g., vehicle operation, position, speed, altitude, direction, rates of change or direction) and actuate to deploy one or more airbags.

Various configurations of airbags can be imagined by those trained in the art, and which are specific to a specific configuration of UAV and/or payload of a UAV without departing from the scope of the invention. Although an exemplary embodiment of a UAV is depicted, the system may be employed in conjunction with other unmanned aerial vehicles. One or more of the features discussed in connection with one or more embodiments may be separately provided or combined together in other embodiments with one or more other features of the vehicles and/or system. In addition, the system is illustrated in conjunction with the vehicle 110, but alternately, the system may be deployed on an existing UAV, and may be provided as a module that includes one or more bags, an inflation mechanism, a trigger, and detection means for detecting a triggering event, so that the bag or bags are inflated.

What is claimed is:

1. A system for deploying an airbag when an unmanned aerial vehicle (UAV) has failed or is no longer able to sustain flight, comprising a triggering means which releases compressed air into a bag or bags which are configured to expand around the UAV for the purpose of reducing the deceleration forces of the UAV on impact.

2. The system of claim 1, wherein the trigger is caused by an accelerometer exceeding a certain acceleration limit.

3. The system of claim 1, wherein the trigger is caused by a loss of power to the motors that power the UAV.

4. The system of claim 1, wherein the trigger is caused by a detector which monitors the current to one or more motors of a fixed wing UAV or quadcopter or octocopter.

5. The system of claim 1, wherein the trigger is caused by a remote command which is issued via a datagram which is transmitted to the UAV over a wireless link.

6. The system of claim 1, wherein one or more airbags envelope the UAV completely on deployment.

7. The system of claim 1, wherein the deployment of the airbags includes an electronic means for cutting power to all rotor motors.

8. The system of claim 1, wherein the deployment of the airbags includes a mechanical means for cutting power to all rotor motors.

9. A system for deploying an airbag when an unmanned aerial vehicle (UAV) has failed or is no longer able to sustain flight, comprising:
a) a triggering means for triggering the admission of gas into an airbag;
b) an airbag configured to be inflated with gas;
c) mounting means for mounting the airbag on a UAV.

10. The system of claim 9, wherein the triggering means is coupled with a supply of a compressed gas.

11. The system of claim 10, wherein said triggering means triggers gas from the supply of compressed gas to inflate the airbag.

12. The system of claim 11, wherein the gas is compressed gas is air.

13. The system of claim 11, wherein the triggering means comprises a valve that regulates the passage of compressed gas from said supply of compressed gas.

14. The system of claim 13, wherein said supply of compressed gas is contained in a reservoir.

15. The system of claim 14, wherein the triggering means comprises a valve that regulates the passage of compressed gas from said reservoir.

16. The system of claim 15, wherein said valve regulates the supply of compressed gas to a plurality of airbags.

17. The system of claim 16, wherein a plurality of reservoirs are provided to supply gas to inflate a plurality of airbags, and wherein said triggering means triggers the admission of gas into the plurality of airbags from the plurality of reservoirs.

18. The system of claim 9, wherein said triggering means comprises a gas producing substance and an actuator for actuating said substance to produce gas.

19. The system of claim 18, wherein said actuator is an ignitor.

20. The system of claim 19, wherein said ignitor comprises a heating element.

21. The system of claim 20, wherein said substance is a nitrogen gas producing substance.

22. The system of claim 9, including circuitry electronically coupled with one or more detectors for detecting a condition of the UAV, and wherein said trigger is electronically coupled to trigger in response to a condition detected by said one or more detectors.

23. The system of claim 22, wherein said one or more detectors comprise detectors selected from the group consisting of accelerometers, current meters, gimbals, inertial measurement units, altimeters, position detectors, and orientation detectors.

24. An unmanned aerial vehicle, comprising:
a) a power source;
b) powering means for powering the vehicle to flight the vehicle; and
c) the system of claim 1.

25. A module for an unmanned aerial vehicle, comprising:
a) a housing;
b) at least one bag configured to be inflated with gas;
c) triggering means for triggering the admission of gas into the bag;
d) mounting means for mounting the housing on a UAV.

26. The module of claim 25, wherein said triggering means comprises a valve or igniter, a sensor for sensing at least one condition, wherein said triggering means is electronically coupled with said sensor to trigger said valve or igniter upon detection of at least one condition.

27. The module of claim 26, wherein said sensor comprises one or more of an accelerometer, current meter, inertial measurement unit, altimeter, position detector, and orientation detector; and wherein said condition comprises a predetermined value threshold programmed in said triggering means, which when reported by said sensor, actuates said trigger to actuate said valve or igniter to inflate said bag.

28. The module of claim 26, wherein said triggering means is remotely actuable.

29. The module of claim 27, wherein said triggering means is remotely actuable
